(19) United States
(12) Patent Application Publication
(10) Pub. No.: US 2009/0037239 A1
(43) Pub. Date: Feb. 5, 2009

(54) Method For Improving Internet Advertising Click-Through Rates through Time-Dependent Keywords

(76) Inventors: Daniel Wong, San Jose, CA (US); Bhaskar Ghosh, Palo Alto, CA (US); Raghotham Murthy, Palo Alto, CA (US)

Correspondence Address: STATTLER - SUH PC, 60 SOUTH MARKET STREET, SUITE 480, SAN JOSE, CA, 95113, US

(21) Appl. No.: 11/833,136

(22) Filed: Aug. 2, 2007

(51) Int. Cl. G06Q 30/00; G06F 17/30; G06F 17/40; G06Q 10/00

(52) U.S. Cl. 705/7

(57) ABSTRACT

A tool that allows internet advertisers to examine the popularity of various different keyphrases entered into a search engine over time is presented. The tool then allows the advertiser to specify a changing set of keyphrases that will be monitored and used to trigger the selection of internet advertisements. In this manner, internet advertisers can take advantage of the different keyphrases used by search engine users that tend to change over time.

### FIELD OF THE INVENTION

The present invention relates to the field of advertising on the internet. In particular the present invention discloses techniques for improving the click-through rates of internet advertisements by using time-dependent keyphrases.

The global Internet has become a mass media on par with radio and television. And just like radio and television content, the rich and interesting content on the Internet is largely supported by advertising dollars. The main advertising-supported portion of the Internet is the “World Wide Web” that displays Hypertext Mark-Up Language (HTML) documents distributed using the Hypertext Transport Protocol (HTTP).

Two of the most common types of advertisements on the World Wide Web portion of the Internet are banner advertisements and text link advertisements. A banner advertisement generally consists of an image or animation that is displayed within an Internet web page. Text link advertisements are generally short segments of text displayed within a designated advertisement area in a web page. Both banner advertisements and text link advertisements are linked to a web site designated by the advertiser.

Since the World Wide Web portion of the internet has grown incredibly large, web viewers often have difficulty locating the specific information that they are interested in. In order to address this problem, many internet search engines have been created. An internet search engine is created by first “crawling” the World Wide Web to learn about the information that is available on the various World Wide Web sites. The output of the crawling of the World Wide Web is a massive index of the web pages that were accessed. Web viewers are then able to search the index of web pages by entering one or more keywords (also known as a “keyphrase”) to locate web pages that contain the entered keywords.

Most internet search engines are supported by advertising. In order to select advertisements that will be of interest to the web viewer, an advertising service provider will examine the keywords entered into the search engine by the web viewer. Specifically, the advertising service provider will attempt to select advertisements for display that are related to the information that the web viewer is seeking to locate. In this manner, the chances that the web viewer will click on the displayed advertisement are greatly improved. Since it is very important to display relevant advertisements to the search engine users, it would be desirable to improve upon the advertisement selection system for internet search engines.

The present invention introduces methods for optimizing internet advertisement selection systems. Specifically, the present invention introduces a tool that allows advertisers to examine the popularity of various different keyphrases entered into a search engine over time. The tool then allows the advertiser to specify a changing set of keyphrases that will be monitored and used to trigger the selection of internet advertisements. In this manner, internet advertisers can take advantage of the different keyphrases used by search engine users that tend to change over time.

Other objects, features, and advantages of present invention will be apparent from the accompanying drawings and from the following detailed description.

### BRIEF DESCRIPTION OF THE DRAWINGS

The objects, features, and advantages of the present invention will be apparent to one skilled in the art, in view of the following detailed description in which:

FIG. 1 illustrates a conceptual diagram of a user at a personal computer system accessing an internet search engine server on the Internet that is supported by an advertising service.

FIG. 2 A illustrates a diagram of a category hierarchy used to represent knowledge.

FIG. 2B illustrates a diagram of a category hierarchy used to represent commonly advertised products and services.

FIG. 3 illustrates a diagram of a category hierarchy with keyphrases associated with some of the categories.

FIG. 4 illustrates a conceptual view of the keyphrase frequency database.

FIG. 5 illustrates an example embodiment of graphical user interface for an internet advertisement campaign optimization tool.

FIG. 6 illustrates a high-level flow diagram describing the partial operation of an internet advertisement campaign optimization tool.

FIG. 7A and 7B illustrates click frequency histograms for all of the selected keyphrases in FIG. 5.

FIG. 8 illustrates a data structure with the top five keyphrases for each hour from the histograms of FIGS. 6A and 6B.

FIG. 9 illustrates an example embodiment of graphical user interface for an internet advertisement campaign optimization tool that allows hour by hour keyphrase adjustments.

FIG. 10 illustrates an example embodiment of graphical user interface for adding additional categories.

### DETAILED DESCRIPTION

Methods for analyzing keywords entered into an internet search engine and subsequently used for selecting electronic advertisement for display are disclosed. In the following description, for purposes of explanation, specific nomenclature is set forth to provide a thorough understanding of the present invention. However, it will be apparent to one skilled in the art that these specific details are not required in order to practice the present invention. For example, although the present invention is mainly disclosed with reference to advertisements placed on search engines on the World Wide Web aspect of the internet, the same techniques can easily be applied in other situations. Specifically, the techniques of die present invention can be used in any application that uses some type of advertisement selector (such as keywords) that can he mapped to a category. Thus, the techniques of the present invention could be used in other advertisement selection applications.

### Advertising Supported Search Engine

The World Wide Web portion of the global Internet has become a mass media that largely operates using advertiser supported web sites. Specifically, web site publishers provide interesting content or services that attract web site viewers. To compensate the web site publisher for creating the interesting content or providing the services, the web site publisher intersperses paid advertisements into the web pages of the web site. Some internet web site advertisements are banner advertisements that consist of an advertiser-supplied image or animation that is displayed to the viewer of the web page. Other internet web site advertisements are text link advertisements that are generally short segments of text that are linked to the advertiser's web site.

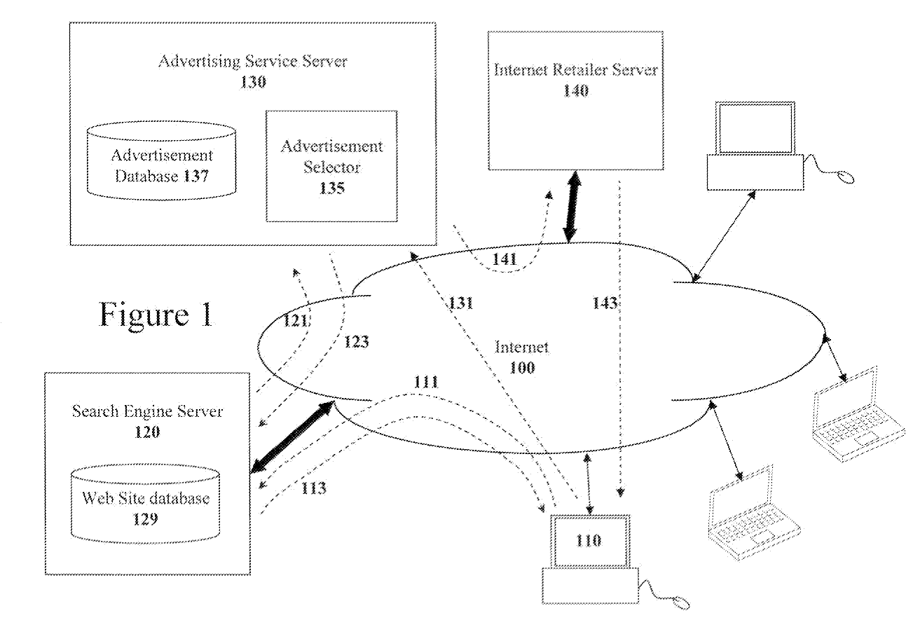

Due to the rise of the “pay-per-click” business model wherein internet advertising services are only paid when a web viewer actually clicks on a display internet advertisement, the internet advertising market has changed. Specifically, it is now critical for internet advertising services to select the internet advertisements that are most likely to obtain the interest of a web viewer in order to get the web viewer to click on the internet advertisement. FIG. 1 presents one possible example of a simple internet advertising system that attempts to select advertisements with an advertisement selector module 135.

Referring to FIG. 1, a web viewer at personal computer 110 may access an advertising supported search engine server 120 in search of some information. The web viewer at personal computer 110 may provide one or more keywords (also known as a “keyphrase”) in search request 111 to the search engine server 120 to specify what type of information the user is attempting to locate. Upon receiving the keyphrase, the search engine server 120 may provide the keyphrase to advertising service server 130 in a request for advertisements message 121.

The search engine then examines its web site database 129 using the keyphrase to locate web pages that will contain the information sought by the user. Similarly, the advertisement selector 135 at the advertising service server 130 will use the keyphrase to select advertisements from an advertisement database 137 that will most likely be of interest to the web viewer. The advertisement selector 135 will provide the selected advertisements along advertisement response message 123 to search engine server 120. The search engine server 120 will then return the search results it located along with the selected advertisements back to the personal computer 110. (Note that advertisement service server could also provide the advertisements directly to personal computer 110.)

If one of the selected internet advertisements is sufficiently interesting to the web viewer at personal computer 110, then the web viewer may click on that advertisement. When this occurs, the advertising service server 130 records the web viewers advertisement click (in order to charge the advertiser for the click-through) and then re-directs the web viewer to the advertiser's designated web site such as internet retailer server 140.

Various different methods may be used by advertisement selector 135 to select advertisements based upon the keyphrase. One method of selecting advertisements based upon keyphrases is to have the advertisers themselves bid on various keyphrases in an auction format. Since the advertisers themselves know their businesses best and wish to obtain the best click-through rate the advertisers will bid the most on keyphrases that are related to their business. Auction based keyphrase advertisement selection systems have provided good click-through rates by displaying advertisements that are relevant to the information that the web viewer was searching for.

It has been discovered that the same keyphrase often does not provide the best results at all times of day. Statistical search data has shown that the same search intent might be expressed using a variety of different keyphrases during the day. For example, people wishing to learn about online video may use the keyphrase “internet tv” “watch tv on-line”, or “on-line tv” during different times of the day. These different keyphrases may be dependent upon local speech patterns. This can result in relevant advertisements not being displayed up for the same search intent at different times of day thus resulting in lower click thru rates (CTR).

### Time-Dependent Keyphrase Overview

To improve click-through rates, the present invention proposes an internet advertising system that allows advertisers to have time-dependent keyphrases. The internet advertising system with time-dependent keyphrases allows advertisers to specify different sets of keyphrases to use during different times of the day. In this manner, advertisers can optimize their advertising campaigns to respond to the changing keyphrases that are used during different times of the day.

Since it is nontrivial for an advertiser to learn about and handle the time varying changes of keyphrases, the present invention introduces tools that examine the history of keyphrases entered by search engine users. The tools allow internet advertisers to optimize their internet advertising campaigns by allowing the use of time varying keyphrases.

In some embodiments, the system allows advertisers to have their advertising campaigns automatically change keyphrases based upon the current popularity of keyphrases. Alternatively, the system may send an alert to an advertiser to allow the advertiser approve of any changes due to changing keyphrases.

### Keyphrase Databases

To implement an internet advertising system with time-dependent keyphrases, specific data must be collected and organized into databases. This section will describe two of the important databases that are created in one embodiment of the present invention in order to implement the internet advertising system with time-dependent keyphrases.

### Keyphrase to Category Database

In order to identify when different keyphrases are being used to refer to the same information being sought, the intent of the search engine users must be abstracted out from the keyphrase entered by the user. To perform this task, the present invention first uses a hierarchical category system to classify all information requests. Then a keyphrase-to-category database is used to store mappings of keyphrases to corresponding entries in the hierarchical category system.

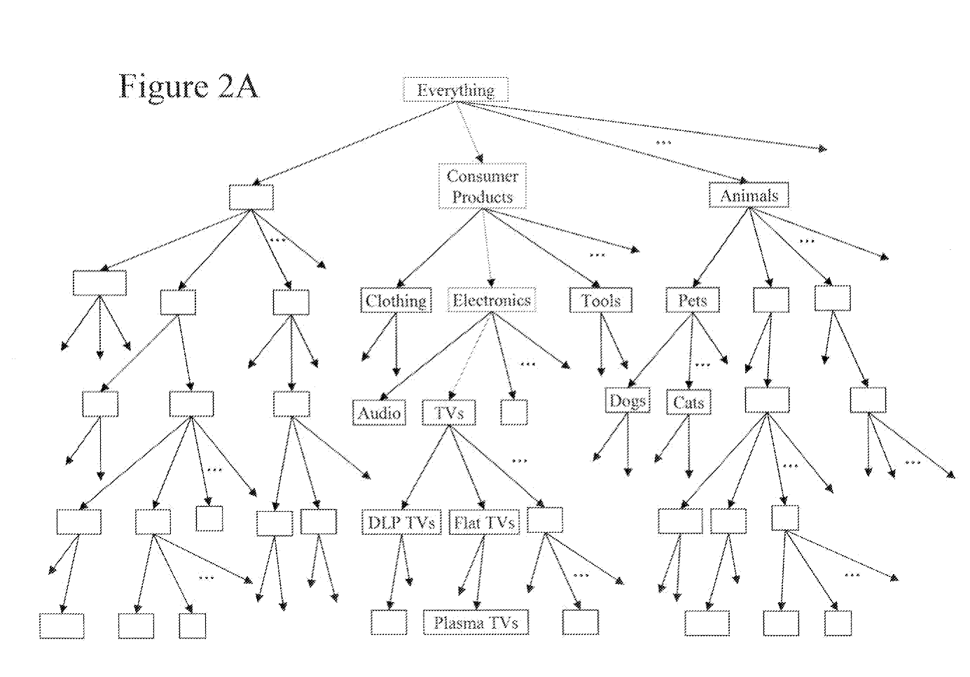

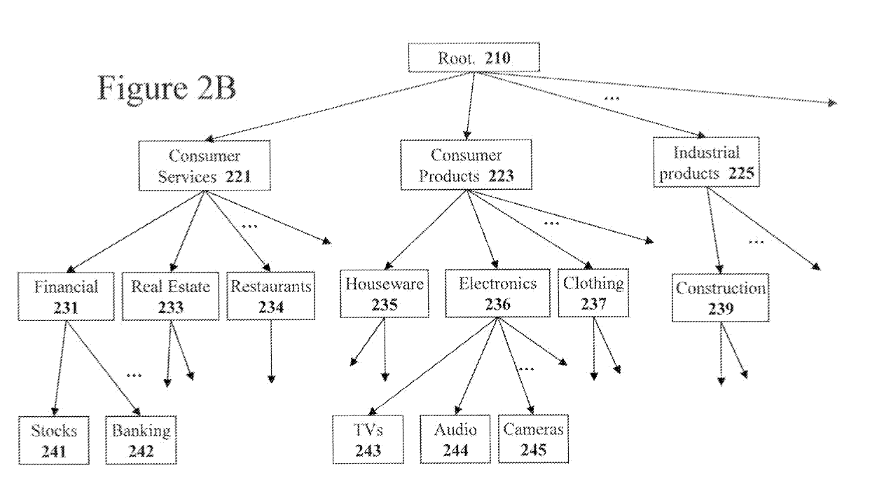

FIG. 2A illustrates a high-level conceptual diagram of a hierarchical category system used to classify all information. A root node at the top encompasses all knowledge. As one progresses down the hierarchy of FIG. 2A, information is organized into successively more detailed categories. As an example, a high-level category may be ‘animals’ as illustrated in FIG. 2A. A sub-category under ‘animals’ could be ‘pets’. Within the ‘pets’ sub-category could be ‘cats’ and ‘dogs’ sub-categories. Under the ‘dogs’ sub-category could be various breeds of dogs. And so on.

In practice, a full hierarchy of all information requests would be extremely large. However, for the needs of the present invention the category hierarchy only needs to be large enough to categorize various interests related to different internet advertisers since the goal is to map keyphrases to appropriate internet advertisements. FIG. 2B illustrates an example category hierarchy geared toward advertisers with high-level categories of ‘consumer services’, ‘consumer products’, and ‘industrial products.’ Below the consumer products category may be clothing, electronics, tools, etc. And so on.

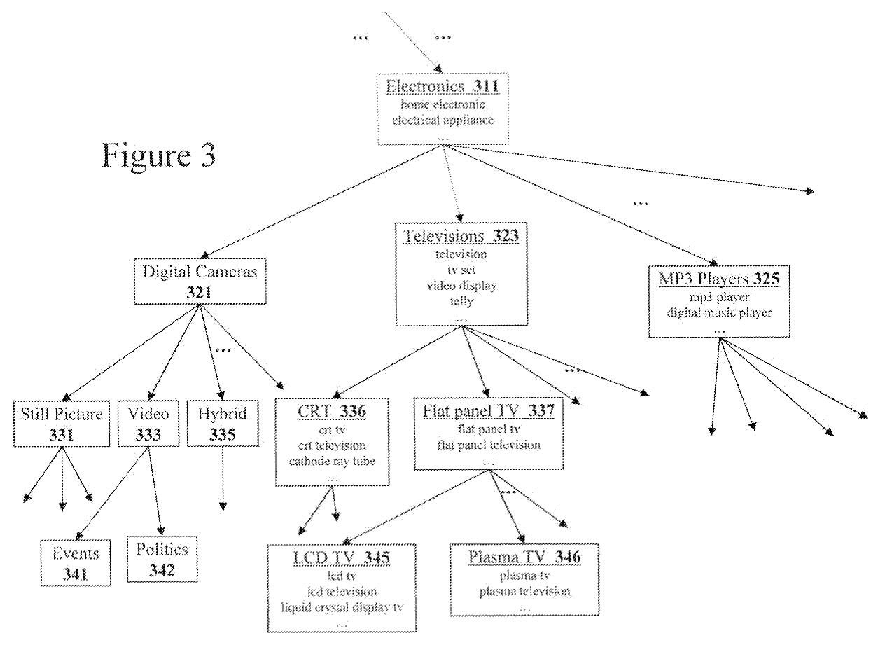

After the creation of a category hierarchy for information requests the next step is to map keyphrases to the categories in the category hierarchy. All keyphrases are mapped to a category in the category hierarchy. FIG. 3 illustrates an example portion of a category hierarchy. In the category hierarchy of FIG. 3 several of the categories are displayed along with lists of keyphrases that are mapped to that category. For example, the keyphrases ‘television’, ‘tv set’, ‘video display’, and ‘telly’ are all mapped to a ./Electronics/Televisions category 323. Similarly, the keyphrases ‘plasma tv’ and ‘plasma television’ are mapped to a ./electronics/televisions/plasmaTV category 346. Note that the structure displayed in FIG. 3 is for conceptual illustrative purposes and that more efficient data structures would be used to actually implement a keyword to category database.

The category hierarchy for information requests may be allowed to grow or shrink as needed. For example, before the ipod was created, the category hierarchy for products from Apple Computer, Inc. obviously did not include a “ipod” subcategory. However, after the Apple ipod was launched, a new subcategory may be created under the Apple category:

```
Consumer Products
  -> Apple
    -> macintosh
      -> downloads
    -> ipod
      -> accessories
      -> nano
      -> faceplates
```

Keywords are mapped to categories. Advertisers select keywords for their advertising campaigns, and the present invention will present relevant keywords under the same category. Furthermore, when the number of keyphrases associated with a particular category grows relatively large, that category should be examined and divided into two or more separate categories.

With a keyword-to-category database, the intent of a search engine user is abstracted out from the keyphrase entered by the search engine user and mapped to a particular category in a category hierarchy. Thus, no matter which keyphrase of ‘televisions’ ‘tv set’, ‘video display’, and ‘telly’ is entered by a user, the user's intent is abstracted to a television category 323 of FIG. 3.

As set forth above, various different keyphrases directed at obtaining the same type information are often seen at different times during the day. To optimize their use of different keyphrases, advertisers need to know when the various different keyphrases are used. Thus, the system of the present invention uses a database to keep track of the click frequency for all the different keyphrases entered by users at different times of the day. In an example embodiment that will be presented, a click frequency will be determined for each hour of the day. However, other implementations could use other reporting periods other than hourly.

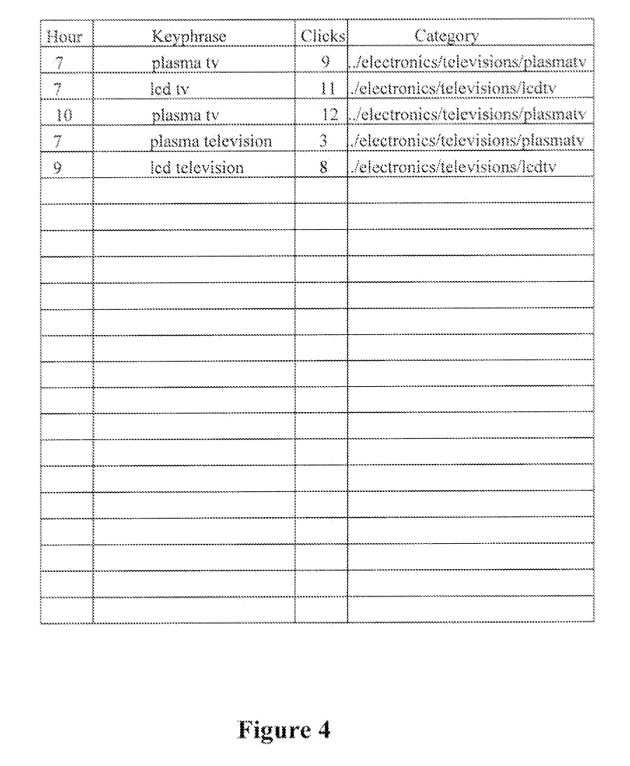

FIG. 4 illustrates a conceptual view of one embodiment of a keyphrase frequency database. Each record of the keyphrase frequency database specifies a particular hour, a particular keyphrase, the number of clicks, and the category that the keyphrase is associated with. The keyphrase field in FIG. 4 specifies a normalized keyphrase that may be entered by a user. The hour field in FIG. 4 specifies the hour of the day reporting period. The frequency field in FIG. 4 specifies the number of clicks that occurred in the last reporting period for the hour specified. Finally, the category field in FIG. 4 specifies the associated hierarchy category for that keyphrase.

For example, the first record. In the database of FIG. 4 specifies that there were nine (‘9’) clicks for the keyphrase ‘plasma tv’ in the last seven a.m. reporting period. Since there are twenty-four hours in a day, there will be twenty-four records (one for each hour) for each different keyphrase and category pair wherein each record specifies the number of clicks that were registered for that keyphrase in that hour of the day.

With the keyphrase-to-category database of FIG. 3 and the keyphrase frequency database of FIG. 4, an advertising system that allows for time dependent keyphrases may be constructed.

### Keyphrase Optimization Tool

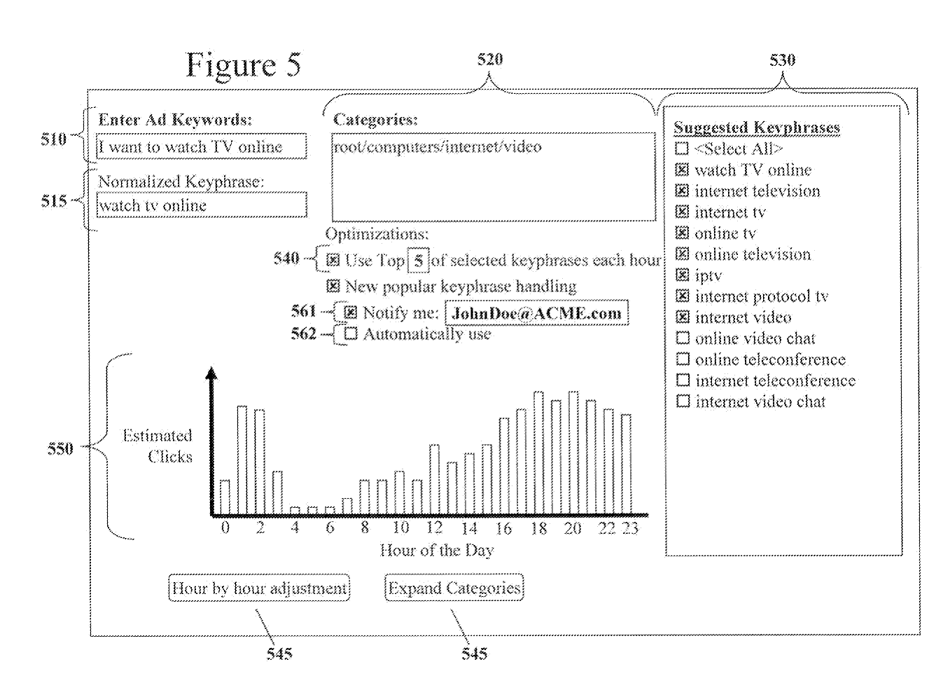

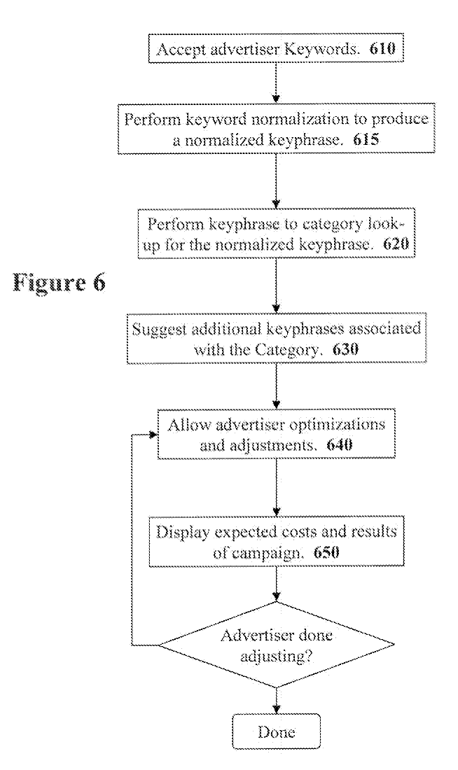

To help advertisers select keyphrases in an optimized manner, the system, of the present invention provides graphical user interlace (GUI) based advertisement campaign optimization tools. FIG. 5 illustrates an example embodiment of graphical user interlace that may be used in conjunction with the keyphrase to category database and the keyphrase frequency database in order to help advertisers optimize their advertising campaign. The basic usage of the graphical user interface will be presented with the flow diagram of FIG. 6.

Referring to step 610 of FIG. 6, an advertiser can enter a set of keywords (at location 510 on FIG. 5) that the advertiser feels that users would enter into a search engine when they are interested in the advertiser's products or services. The advertiser may also enter other searches wherein the advertiser believes the customer should be interested in the advertiser's products or services. Next, at step 615, the advertising optimization tool will normalize the keywords entered in location 510 to produce a normalized keyphrase that is displayed in location 515.

The normalization process puts the keywords into a canonical form. The normalization process may eliminate all white space, capitalization, and punctuation. The normalization process may also eliminate stop words such as ‘a’, ‘the’, ‘in’, etc. The normalization process may also change plural words into singular form. In FIG. 5, an example is illustrated wherein an advertiser has entered “I want to watch TV online” and the tool has normalize this into the keyphrase “watch tv online”.

After normalization, the advertisement campaign optimization tool performs a keyphrase to category look up at step 620 to determine the category that the keyphrase in area 515 belongs to. The category is then displayed in category display area 520. The category displayed in category area 520 may be broader than a advertiser desires or narrower than the advertiser desires. However, in either case adjustments can be made to compensate for this difference as will be set forth later. If the advertiser is not satisfied, the advertiser may request that a new category be created.

### Keyphrase Suggestions

Referring back to FIG. 6, the advertisement campaign optimization tool proceeds to step 630 where the advertisement campaign optimization tool suggests additional keyphrases that the advertiser may wish to consider. In one embodiment, the advertisement campaign optimization tool may suggest additional keyphrases by listing all of the other keyphrases that are associated with the category identified in step 620 and displayed in category area 520. FIG. 5 illustrates a set of suggested keyphrases displayed in keyphrase area 530.

If the list of keyphrases associated with a category is very large, the advertisement campaign optimization tool may perform a ‘closeness’ test to determine the keyphrases in the category most ‘close’ to the advertiser's entered, keyphrases. For example, this may be performed by selecting keyphrases with some of the same keywords in the advertiser's keyphrase. Similarly, the system may add keyphrases with keywords that are synonyms to words in the examiner entered keyphrase.

Referring back to FIG. 6, the system then allows the advertiser to make adjustments at step 640. The advertiser can freely select among the suggested keyphrases displayed in keyphrase area 530 of FIG. 5. If the advertiser is interested in using a suggested keyphrase, the advertiser can check a box in front of the suggested keyphrase. If the advertiser feels a suggested keyphrase is not appropriate, then the advertiser will not check the box in front of that suggested keyphrase.

By not selecting various suggested keyphrases, the advertiser is effectively narrowing the scope of the category displayed, in category area 520. For example. FIG. 5 illustrates a list of suggested keyphrases for the advertiser normalized keyphrase of “watch tv online” in area 530. In the list of suggested keyphrases in area 530 most of the keyphrases are very similar to the desired normalized keyphrase of “watch tv online”. However, several of the suggested keyphrases deal with video conferencing and video chat. By not selecting those particular keyphrases, the advertiser has effectively narrowed the scope of the category as it applies to the advertiser's campaign.

Referring back to FIG. 6, the advertisement campaign optimization tool will display the expected costs and click-through rates for the campaign at step 650. For example, a histogram can be used to display an estimated performance for the advertiser's campaign as illustrated in area 558 of FIG. 5. As an advertiser selects and unselects various keyphrases, the bars on the histogram will adjust accordingly.

### Time Dependent Optimization Suggestions

in FIG. 5, an advertiser has selected eight (8) keyphrases to be monitored and used to trigger the display of the advertiser's advertisements. However, it may be too complicated and counter-intuitive for an advertiser to have eight keyphrases monitored concurrently. One important function of this advertising tool is to present the top keyphrases that give the highest click-through rate for each time period. There are at least two modes of usage of the advertising tool:

1) Advertiser specified (as set forth above)

2) Automatic mode where the advertiser does not have to monitor the keyphrases per time period. Instead, the tool automatically uses the “top N best” keyphrases to use per time period (e.g. hourly).

To use all of those keyphrases but in a less expensive and optimized manner, the advertisement campaign optimization tool of the present invention allows the advertiser to specify that the Top N keyphrases of the selected keyphrases to be monitored wherein N is a number that may be set by the advertiser.

Referring to. FIG. 5, area 540 illustrates an optimization that may be selected by an advertiser to “Use Top 5 of selected keyphrases each hour.” The number five (‘5’) is just an example value and the user may change that to a different value. When an advertiser selects that optimization, the advertisement campaign optimization tool will build a data structure that lists the top N keywords for each hour in a twenty-four hour period. That data structure will be used by an advertising service provider to determine when the advertiser's advertisements will be displayed.

For example, in FIG. 5, the advertiser has selected eight (8) keyphrases in keyphrase area 530. To limit the use of the keyphrases, the advertiser has selected the optimization in area 540 to specify that they system only use the five most popular keyphrases each hour from the selected keyphrases in keyphrase list 530. To implement this, the advertisement campaign optimization tool will first examine the keyphrase frequency database. Specifically, the advertisement campaign optimization tool will extract the click frequency for every selected keyphrase for all of the time periods. Then, the advertisement campaign optimization tool will select the top five keyphrase for each different time period and place those keyphrases in a data structure.

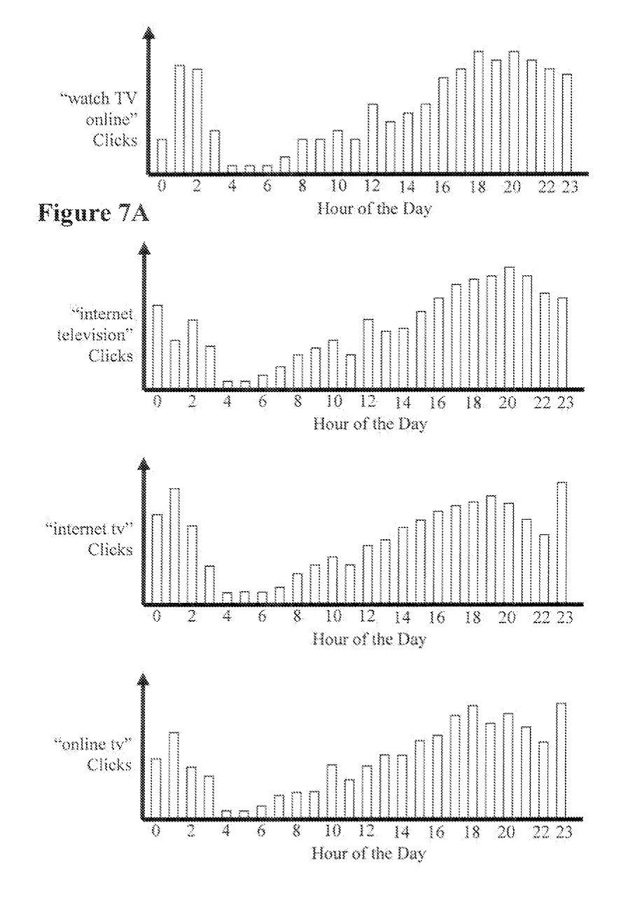

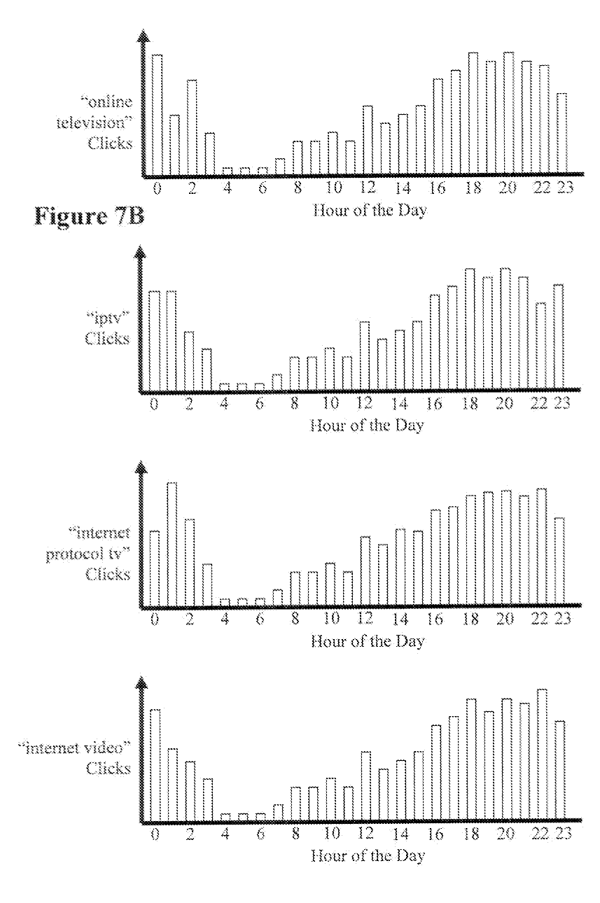

This process can be visually demonstrated with the use of histograms. FIG. 7A and 78 illustrates histograms for ail of the selected keyphrases in FIG. 5. Each keyphrase histogram has a horizontal axis that specifies the twenty-four one hour time periods. (Note that other implementations can use other time period sizes.) The vertical axis specifies the number of clicks that were received for that keyphrase in the most recent sample of that time period. Thus, each keyphrase histogram has twenty-four vertical bars that represent the number of clicks that occurred in that hour.

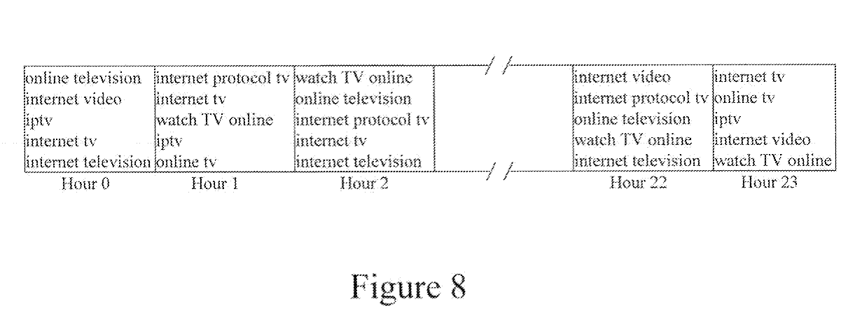

The optimization would proceed through each hour selecting the top N (five in this example) keyphrases with the tallest bars (most number of clicks) for that hour, for example, the keyphrases “online television”, internet video”, “iptv”, “internet tv”, and “internet television” have the tallest bars (and thus largest numbers of clicks) for hour zero. Thus, those five keyphrases would be monitored for hour zero each day. FIG. 8 conceptually illustrates a data structure with the top five keyphrases for each hour. A system that that selects internet advertisements such as advertisement selector 135 of FIG. 1 could examine the data structure of FIG. 8 to determine if its associated advertiser's advertisements should be displayed.

### Time Dependent Adjustments

In one embodiment, the system allows the advertiser to one tune the time dependent keyphrases that will be monitored. For example, after selecting the top live keyphrases for each hour as specified in the previous section, a user may select the “Hour by hour adjustment button 545 on FIG. 5 to bring up a graphical user interlace for adjust individual hours.

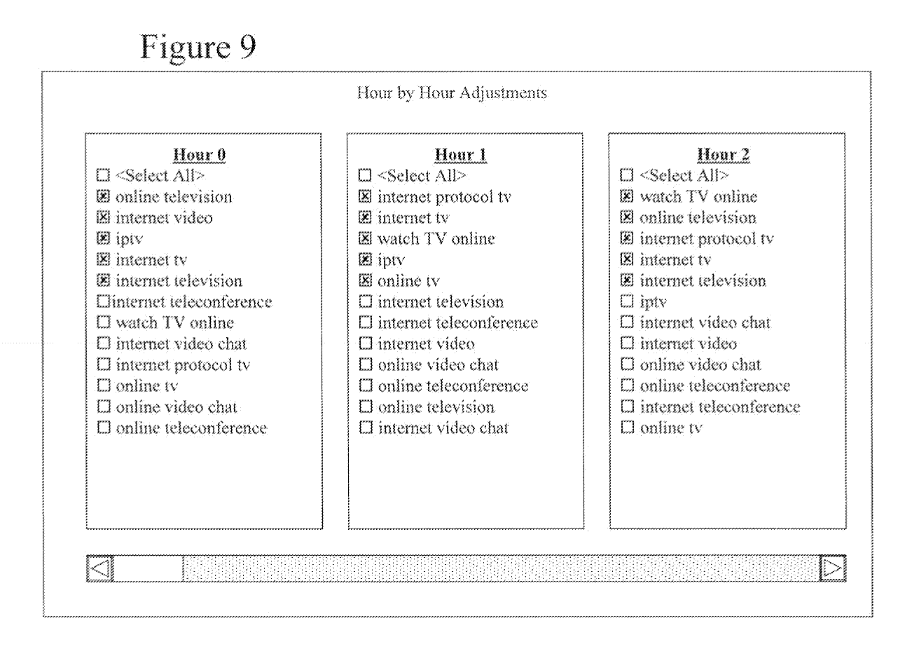

FIG. 9 illustrates a graphical user interlace wherein the suggested keyphrases are each displayed in order of popularity (click frequency) for the first three hours. (The user can scroll to the right for the later hours.) In each hour, the top five most popular keyphrases have been selected. The advertiser can customize each hour by adding additional keyphrases or removing keyphrases.

### New Popular Keyphrase Handling

Over time, the keyphrases entered into a search engine tend to change. News events can cause certain keyphrases to suddenly gain in popularity. When a new keyphrase is associated to a category that an advertiser is interested in, the advertisement campaign optimization tool can have the search engine automatically perform an action on behalf of the advertiser.

In one embodiment, if an advertiser selects checkbox 561 then the advertiser will be notified when a new popular keyphrase has been detected in a category that the advertiser is interested in. A text box allows the advertiser to enter an email address where notifications can be sent. When the advertiser receives an email notification about a new popular keyphrase, the advertiser may decide to adjust the keyphrase settings for the advertiser's internet advertising campaign in response to the new popular keyphrase

Another option is illustrated with checkbox 562 that specifies “Automatically use.” When an advertiser selects checkbox 562, the system will automatically add new popular keyphrase into the advertisers list of keyphrases to be used as a trigger for displaying the advertiser's internet advertisements.

### Expanding Categories

Some categories may be too narrow for an advertiser or may contain an insufficient set of keyphrases. When this occurs, an advertiser can select the expand categories button 546 on the advertisement campaign optimization tool graphical user Interface of FIG. 5.

To expand categories, the advertisement campaign optimization tool may add sibling and parent categories. For example, referring to the category hierarchy of FIG. 3, an advertiser than is in the plasma TV category 346 would have the LCD TV category 345 and flat panel TV category 337 added. This addition of categories would present the user with many more keyphrase options in the suggested keyphrase area 530.

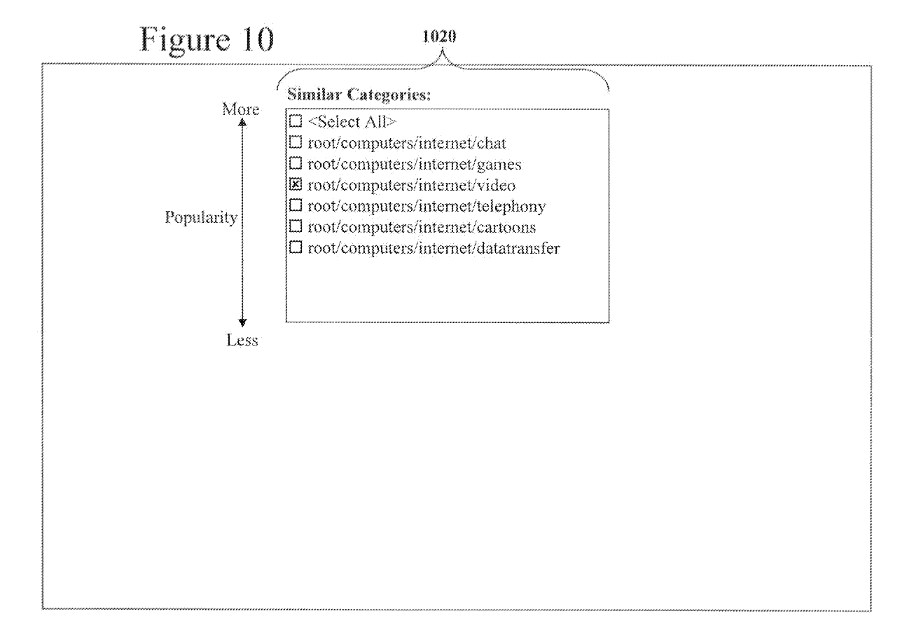

In one embodiment, the system would display a list of similar categories to the users. FIG. 10 illustrates one possible graphical user interface screen wherein the advertisement campaign optimization tool displays a list of similar categories and displays the categories in order of popularity. In this manner, the advertiser can decide to add additional categories. After adding a category, the system could then add keyphrases from that category to the suggest keyphrase area 530.

The foregoing has described a number of techniques for analyzing keywords entered into an internet search engine and subsequently used for selecting electronic advertisement for display. It is contemplated that changes and modifications may be made by one of ordinary skill in the art, to the materials and arrangements of elements of the present invention without departing from the scope of the invention.

We claim:

1. A method of selecting keyphrases used to trigger electronic advertisements, said method comprising die steps of:
monitoring a performance metric for keyphrases used in a search engine for a plurality of different time periods;
storing said performance metrics for said keyphrases in a database; and
selecting a set of keyphrases for each different time period for an advertising campaign based upon said performance metric.

2. The method of selecting keyphrases used to trigger electronic advertisements as set forth in claim 1 wherein said performance metric comprises a click-through rate.

3. The method of selecting keyphrases used to trigger electronic advertisements as set forth in claim 1 wherein keyphrases comprise a normalized set of keywords entered into said search engine.

4. The method of selecting keyphrases used to trigger electronic advertisements as set forth in claim 3 wherein a normalization process removes capitalization, stop words, and plural forms of words.

5. The method of selecting keyphrases used to trigger electronic advertisements as set forth in claim 1 further comprising the step of:
mapping each keyphrase to a category in a category hierarchy;

6. The method of selecting keyphrases used to trigger electronic advertisements as set forth in claim 5 further comprising the step of:
suggesting additional keyphrases from a same category assigned to an advertiser entered keyphrase;

7. The method of selecting keyphrases used to trigger electronic advertisements as set forth in claim 6 wherein said additional keyphrases are displayed in order of popularity.

8. The method of selecting keyphrases used to trigger electronic advertisements as set forth in claim 5 further comprising the step of:
displaying a list of categories ranked by popularity wherein said popularity is dependent on how often keyphrases associated with said category are entered into said search engine

9. The method of selecting keyphrases used to trigger electronic advertisements asset forth in claim 5 further comprising the step of:
suggesting additional keyphrases from categories that share a common parent as said category assigned to said advertiser entered keyphrase.

10. The method of selecting keyphrases used to trigger electronic advertisements as set forth in claim 5 further comprising the step of:
suggesting additional keyphrases from a parent category of said category assigned to said advertiser entered keyphrase.

11. The method of selecting keyphrases used to trigger electronic advertisements as set forth in claim 5 further comprising the step of:
sending an alert to an advertiser when a new keyphrase becomes a popular in a category that said advertiser is interested in.

12. A computer readable medium, said computer readable medium comprising a set of computer instructions for selecting keyphrases used to trigger electronic advertisements, said computer instructions implementing the steps of:
monitoring a performance metric for keyphrases used in a search engine for a plurality of different time periods;
storing said performance metrics for said keyphrases in a database; and
selecting a set of keyphrases for each different time period for an advertising campaign based upon said performance metric.

13. The computer readable medium as set forth in claim 12 wherein said performance metric comprises a click-through rate.

14. The computer readable medium as set forth in claim 12 wherein keyphrases comprise a normalized set of keywords entered into said search engine.

15. The computer readable medium as set forth in claim 12 wherein said computer instructions further implement the step of:
mapping each keyphrase to a category in a category hierarchy;

16. The computer readable medium as set forth in claim 12 wherein said computer instructions further implement the step of:
suggesting additional keyphrases from a same category assigned to an advertiser entered keyphrase;

17. The computer readable medium as set forth in claim 15 wherein said computer instructions further implement the step of:
displaying a list of categories ranked by popularity wherein said popularity is dependent on how often keyphrases associated with said category are entered into said search engine

18. The computer readable medium as set forth in claim 15 wherein said computer instructions further implement the step of:
suggesting additional keyphrases from categories that share a common parent as said category assigned to said advertiser entered keyphrase.

19. The computer readable medium as set forth in claim 15 wherein said computer instructions further implement the step of:
suggesting additional keyphrases from a parent category of said category assigned to said advertiser entered keyphrase.

20. The computer readable medium as set forth in claim 15 wherein said computer instructions further implement the step of:
sending an alert to an advertiser when a new keyphrase becomes a popular in a category that said advertiser is interested in.
